(19) United States
(12) Patent Application Publication
(10) Pub. No.: US 2025/0228172 A1
(43) Pub. Date: Jul. 17, 2025

(54) System, Method and Framework for Plant Growth

(71) Applicants: Jeffrey Fenley, Weslake Village, CA (US); Vasily Bogatov, St Petersberg (RU); Patrick Avakian, Laguna Beach, CA (US)

(72) Inventors: Jeffrey Fenley, Weslake Village, CA (US); Vasily Bogatov, St Petersberg (RU); Patrick Avakian, Laguna Beach, CA (US)

(21) Appl. No.: 18/412,385

(22) Filed: Jan. 12, 2024

Related U.S. Application Data
(60) Provisional application No. 63/479,665, filed on Jan. 1, 0001.

(51) Int. Cl. A01G 31/00; A01G 7/02; A01G 7/04; A01G 25/16; G16Y 20/10; G16Y 40/10

(52) U.S. Cl. CPC A01G 31/00; A01G 7/02; A01G 7/045; A01G 25/167; G16Y 20/10; G16Y 40/10

(57) ABSTRACT

An apparatus, systems, methods and platforms/frameworks for growing plants, vegetables, herbs and other agricultural products. Specifically, the present disclosure allows for a highly controlled environment capable of minuscule adjustments to the environment over time to optimize plant growth.

### CROSS REFERENCE TO RELATED PATENT APPLICATIONS

This application claims priority from U.S. Provisional Patent Application No. 63/479,665, filed on Jan. 12, 2023, in the United States Patent and Trademark Office, the disclosure of which is incorporated by reference herein, in its entirety.

### FIELD OF THE INVENTION

The present disclosure relates to systems, methods and platforms/frameworks for growing plants, vegetables, herbs and other agricultural products. Specifically, the present disclosure allows for a highly controlled environment capable of minuscule adjustments to the environment over time to optimize plant growth.

### BACKGROUND ART

The recent advent of indoor agriculture and vertical farming has resulted in greater and robust harvests of plants, vegetables, fruits, herbs and other agricultural growth. Favorable control factors, such as light, temperature and humidity have yielded bounties of crops while minimizing resources and energy.

Specifically, the cannabis industry has capitalized greatly from indoor growth due to the delicate nature of cannabis. Generally, cannabis is a genus in the family cannabaceae (also known as the hemp family), and the division Manoliophyta (the flowering plants). Cannabis has unique pharmacological properties due to the presence of cannabinoids, a group of more than 100 natural products that mainly accumulate in female flowers. Δ9-Tetrahydrocannabinol (“THC”) is the principle psychoactive cannabinoid and the compound responsible for the analgesic, antiemetic and appetite-stimulating effects of cannabis. Careful cross-breeding and selection of cannabis along with optimized cultivation practices have led to increased yield and potency. This breeding effort has produced hundreds of strains that differ in cannabinoid composition, as well as appearance and growth characteristics.

As more and more states are legalizing the recreational use of cannabis, and more and more research is uncovering the benefits of cannabis, the demand for controlled and improved cultivation and breeding practices has increased, thereby improving the quality, reproducibility, and quantity of cannabis available on the marketplace.

Current cannabis growth methods require cultivators to set up permanent and complex indoor facilities to properly grow cannabis. Such facilities have limited capabilities, including requiring the installation of many types of equipment and consuming large amounts of energy. For example, known cannabis growth methods typically face challenges like fungal infestation, difficulty in controlling the climate in the plants' environment, the requirement of high levels of power consumption to power the necessary environmental controls, like HVAC systems, lighting, humidifiers, not to mention high level of detailed human interaction required to keep the environment stabile and optimized throughout the grow cycle.

More generally, the current cannabis grow systems are expensive to maintain because of the extensive systems, both technological and human, that are required for a successful grow cycle. Furthermore, the highly sensitive nature of the cannabis plant requires exhaustive and constant monitoring and nurturing to ensure a successful plant, which requires not only experienced cultivators, but the constant monitoring of the plants to ensure proper growth. The continual monitoring, intervention and adjustment of variables during all aspects of the cannabis plants' growth cycle, beginning from managing the plants' environment for optimal growth, such as CO2 levels, temperature, humidity, etc. to the plants' cultivation and processing, is highly taxing on the cultivator.

Accordingly, it would be highly beneficial to develop cannabis growth methods and systems that are able to produce higher growth rates, improved plant quality, and self-monitoring of environmental factors to produce optimized cannabis plants.

### SUMMARY OF THE DISCLOSURE

The present disclosure is related to systems, methods and platforms for plant growth, including an internet of Things (IoT) platform, that allows indoor agricultural growth facilities to automate critical functions such as climate, irrigation, and lighting, resulting in the savings of time and labor, and enhanced environmental stability, which leads to higher yields and greater profit of the cultivation. Through the combination of intelligent hardware devices (GC Devices) that are connected to the internet, and a software application (GC App) that allows for thorough monitoring and control of the devices within a facility, a user can quickly and easily automate and control a facility's vital functions. Unlike traditional control and automation devices that must be programmed for task-specific functions, the subject platform is purpose-built so that all devices are easy to install, scalable, and can communicate with each other and learn to function more efficiently in achieving user targets. It is a smart system that is instantly scalable to any size. A complex purpose-built automation ecosystem for the indoor agriculture industry with fast and efficient deployment and scalability has thus far not been achieved by any known competitors.

Furthermore, the subject application discloses methods, systems, apparatus and backbone/structures for managing an indoor hydroponic system, comprising: providing a plurality of sensors in a hydroponic growth room; communicating data from the plurality of sensors to a computer readable storage medium having program instructions; analyzing the sensed data from the plurality of sensors using the computer readable storage medium; comparing the analyzed sensed data with a predetermined optimal growth room using the computer readable storage medium; determining one or more changes needed in the sensed data to accomplish the predetermined optimal growth room; communicating the one or more changes to a climate control suite to enact the one or more changes; and monitoring data communicated from the plurality of sensors to arrive at the predetermined optimal growth room.

### DETAILED DESCRIPTION OF THE DISCLOSURE

In the following description, reference is made to the accompanying drawings which are illustrations of embodiments in which the disclosed invention may be implemented and practiced. It is to be understood, however, that those skilled in the art may develop other structural and functional modifications without departing from the novelty and scope of the instant disclosure.

As will be appreciated by those skilled in the art, the present examples may be embodied as a system, method or program product. Accordingly, some examples may take the form of an entirely hardware embodiment, an entirely software embodiment (including firmware, resident software, micro-code, etc.) or an embodiment combining software and hardware aspects that may all generally be referred herein as a “circuit”, “module” or “system”. Further, some embodiments may take the form of a computer program product embodied in any non-transitory tangible medium of expression having computer-usable program code stored therein.

The terms first, second, third, etc. may be used herein to describe various elements, components, regions, parts and/or sections. It should be understood that these elements, components, regions, parts and/or sections are not limited by these terms of designation. These terms of designation have been used only to distinguish one element, component, region, part, or section from another region, part, or section. Thus, a first element, component, region, part, or section discussed below could be termed a second element, component, region, part, or section merely for purposes of distinction but without departing from structural or functional meaning.

### Facility/Room Navigation

Clear, concise, and efficient navigation of a facility's controlling functions, including management of hundreds, or even thousands of connected devices, requires careful implementation; particularly in an environment where, at any given moment, millions of dollars of crop are at risk. Facility administrators must be able to quickly and intuitively understand the system without a steep learning curve and they must be able to quickly jump to any facility, any room, and any function they need to access, and adjust the environment without undue experimentation or haste.

With just a few button clicks, the GC App allows an end user to create a virtual digital facsimile of their entire grow enterprise, including geographically dispersed facility locations, and the individual grow rooms within these facilities. Once a virtual digital facsimile has been created, the user can then deploy GC Devices within the facility by a fast and efficient process that consists of paring a device to the internet, and scanning the device's QR code in the GC App. Once GC Devices are added to a room, they automatically adopt the room's settings and they can then all communicate with each other to regulate equipment and accurately maintain user-defined parameters. We call this process ‘automation in minutes, not months’ because of the massive time savings in deployment, compared to any other option. A full-facility GC automation system consisting of hundreds of devices can be deployed in as fast as a day, and typically in less than a week, compared to many weeks or months for currently available systems. And staff can be trained on use of the system in under an hour.

### Climate Control

Commercial indoor growing requires finely-calibrated environmental parameters in order optimize high value crops to express their ultimate potential. A combination of temperature, relative humidity, nutrients, pH, and CO2 levels must be precisely maintained in relation to each other to keep crops in their ideal growing zone and to maximize plant metabolism. Granular control over every degree of temperature, every percentage point of humidity, and every part per million of CO2 are vital to producing the highest quality crop output in the shortest amount of time.

Managing climate in a commercial indoor growing environment is a much different task than cooling or heating a standard home or even a large office building. Commercial grow rooms have the challenge of heavy-duty cooling to compensate for all of the heat generated by the grow lights. In addition, as plants grow and transpire, they inject hundreds of gallons of moisture into the air per day. Industrial dehumidification equipment is needed to remove this extra moisture and keep humidity levels in the ideal range. CO2 must be injected into the room and kept at an optimal level, depending on temperature and other factors.

A typical grow room, of which there are usually many within a given facility, may contain six or more industrial HVAC units and Dehumidification units. This is 12 large industrial appliances in just one room that needs to be controlled with as much precision as possible. Making climate management more complex is that the temperature and humidity must be maintained at levels that are precise in relation to each other, as measured by Vapor Pressure Deficit (VPD).

The need for precision control over the climate, and having a vast number of industrial climate equipment in a given room to control, necessitates a much more advanced control system than the standard thermostats and humidistats which are predominately used today. A system where control devices can talk to each other and work together to control climate appliances and achieve the user's targets in the most efficient manner. GC Devices are small IoT controllers that connect to each climate appliance (HVAC, Dehumidifier, Humidifier, CO2 dispenser, pH reader and soil monitor) and allow them to be automated by the GC App. The GC App is a unified platform that manages and directs all GC Devices, and upon which all equipment can talk with each other, gather data, and make intelligent decisions on how best to maintain more stable environmental parameters.

Some things that make it special are granular control over settings that users do not normally have access to, and proprietary logical functions that perform routines that manipulate climate in ways that are not currently achievable with any current control systems.

### Climate Mode Switching Algorithm

Typical thermostats, including new smart thermostats, that control an HVAC unit can only operate in one mode at a time: either heating, or cooling. If an HVAC unit is in cooling mode, it requires user intervention to change to heating mode. This is because HVAC units are normally only used in one mode during a given season. During summer, the unit will always be in cooling mode, and during winter, it will always be in heating mode. Indoor growing requires more complex control. Cooling and heating might both be required during any given 24-hour period. The subject innovation has devised an algorithm that automates the process of switching between HVAC cooling and heating modes. The algorithm allows fine-tuning by the user in the form of variables that can be manipulated. The algorithm works in this way: Any HVAC thermostat when in use has a mode and a setpoint. For instance: Cooling mode, 78° F.; or Heating Mode, 80° F. are two examples of mode and setpoint. Hardcoded into the thermostat is a ‘dead-band,’ sometimes referred to as ‘hysteresis.’ When you set a thermostat to 78° F., there is a hysteresis range of approximately 1 or 2°. The thermostat may turn the AC on when the temperature hits 79° F., and turn it off when it hits 77° F., effectively maintaining a temperature range of 77-79. If the temperature maintains above 79°, the AC will continue to stay on, trying to cool until 77° is reached. But what happens when the temperature drops below 77°? What if it drops to 70° and starts getting very cool? In order to bring the temperature back up, the user must come to the thermostat and switch it to heating mode. This is not practical because the temperature may fluctuate often, and the goal is to maintain a tight temperature range with minimal variation.

The subject innovation has developed a control algorithm whereby our hardware can automatically change system modes based on a set of rules, and based on some variables input by the user. In a commercial indoor grow environment both cooling and heating may be required from the same appliance, necessitating an automated mode switching mechanism, as an end user cannot come to the room and change modes every time it's necessary. Our Algorithm allows the user to select a threshold at which the system changes modes. The following diagram (Diagram 1) illustrates a situation where the system is in cooling mode with a setpoint of 80° F., but the temperature has fallen below the lower hysteresis threshold and cooling is no longer required. The user has specified a Cool to Heat switchpoint of T-7 (Temperature setpoint, minus 7°), so if the temperature falls to 73° F., the system mode will switch to heating, and the system will use heat to maintain the temperature setpoint of 80° F. And vice versa. If the climate becomes too warm, the switching algorithm will change to cooling mode.

### Diagram 1

### Climate Control by VPD; Hardware Controllers and Algorithm

Vapor Pressure Deficit (VPD) is the difference between how much moisture is in the air, and how much moisture the air can hold. VPD is measured in kilopascals (kPa). The ideal VPD range for plant grow is roughly 0.80-1.25 kPa. A practical example makes it easy to understand: If you want to maintain a temperature of 80° F. in your grow

environment, with a VPD of 1.10 kPa, the relative humidity should be maintained at 68.2% according to the formula. The value for humidity changes based on the temperature and VPD variables and the formula for calculating VPD. In order to accurately control the climate by VPD, you must have control over HVAC and Dehumidification/Humidification equipment by one smart system that can control all functions of the climate appliances to maintain VPD targets. For instance, traditional HVAC systems use a thermostat to maintain a user-set temperature level.

Dehumidification/Humidification systems use a humidistat to maintain the humidity level. But the thermostat(s) and humidistat(s) do not talk to each other. You can't tell either one to maintain a VPD of 1.10 kPa. You can set your thermostat to 80° F. and then you can use a tool to calculate your humidity for a 1.10 VPD, based on your temperature, and then set your humidistat to 68.2% RH and hope for the best. It is a manual process that is very time consuming, requires setting and programming multiple devices and requires the use of a tool or conversion table to locate the humidity variable you need to program into your humidistats.

Since GC Devices connect to and control the HVAC and Humidity equipment in one unified system, the subject innovation allow the end user to control and adjust many additional features that cannot be accomplished by thermostats and/or humidistats, through the GC App. To control climate by VPD, a user simply specifies their target temperature and VPD level and the system automatically sets and maintains the perfect humidity level with no further input needed from the user. Together, the system and devices work to control the climate appliances, both HVAC and humidity equipment, and maintain the ideal VPD.

As grow rooms can become quite large in size, density of plants and other factors, leading to hot spots or variance in temperature and humidity in the room, the subject system may control an infinitely scalable number of HVAC and Humidity appliances within one room to ensure the VPD in the entire room is consistent and working together towards homeostasis. As all the appliances and GC Devices are controlled by one smart system, the user is able to use VPD settings to control climate.

### Device Scalability/Staging Algorithm

A typical indoor grow environment contains many climate appliances, their interaction amongst each other is important. The subject innovation allows an end user to add as many climate controllers to a room as needed, with no practical, physical or virtual limits. And through the GC App, the user can input their desired climate parameters for the room one time, and the GC App then synchronizes all of the controllers in the room with the user settings for that room. The controllers then instruct all of the climate appliances as to what they should be doing, based on the GC App's control algorithms. There is no need to set each controller individually, as is the case with thermostats and humidistats.

Accurately maintaining climate parameters in a large room with many climate appliances is complex. For example, a room with a temperature parameter of 80° F., and that has six large HVAC units, may not need all 6 units running simultaneously at a given time. The system needs to know how to stage the units on and off as needed to use them most efficiently and to maintain the climate parameters most accurately. As stated previously, the humidity and other factors in the room are also factors to consider when deploying the HVAC units, as humidity and other factors weight heavily on the rate at which the HVAC units may cool the room. The GC App has an algorithm that allows the user to stage their climate appliances to work most efficiently for their environment, which aids in maintaining the most stable and accurate climate parameters. The algorithm will decide how many HVAC units need to be activated to maintain the user-defined parameters, taking into account other environmental factors within the room (eg, Humidity, pH, etc). This results in energy savings and tighter control of climate variation.

### Climate Learning Algorithm

Maintaining tight climate parameters is much more difficult than it sounds. As an example, let's say there is a room with a temperature parameter of 80° F. and a hysteresis of 2° F., meaning the system will maintain a range of 79-81° F. Cooling starts at 81° F. and stops at 79° F. during a typical cooling cycle. While this sounds easy on paper, in reality, something different happens: When cooling equipment is triggered to turn on at 81°, the temperature continues to rise for some time until the cool air begins to fill the room and circulates. The temperature may actually rise significantly above the upper hysteresis band to say 83° before the cooling begins to take effect. Conversely, the same is true: when the temperature of 79° F. is reached and the cooling equipment is turned off, the temperature continues to fall for a while as the cool air circulates. It may reach 78° F. So, although the system intends to keep a temperature range of 79-81° F., it is in reality maintaining a much wider band of 78°-82° F.

The subject innovation incorporates a learning Algorithm which analyzes actual historical climate parameters gathered from the room and compares them to what would have been expected, based on user settings, and utilizes the algorithm for solutions to more accurately maintain climate parameters and match real-world results closer to user expectations.

### Advanced Irrigation Controller

The GC Devices Advanced Irrigation Controller (AIC) is a hardware controller that connects to and controls end-point irrigation solenoids that directly water the plants, and also connects to and controls diverter valves that supply different strength nutrient solutions to a room's irrigation system. With the AIC, a user can program the delivery of a specific nutrient solution recipe, as required during the plants current growth stage, as well as dispense this specific solution directly to the plants. Due to the fact that nutrients and irrigation cycles effect room humidity and temperature, the subject innovation may incorporate irrigation and nutrient cycles to control VPD, and further regulate and incorporate irrigation and and nutrition timing to control VPD based on a predictive model.

### Substrate Monitoring/Irrigation Algorithm

In commercial hydroponics production, the root zone of the plant is supported by a medium; normally rockwool or some other soilless mixture. Monitoring the root zone for temperature, moisture level, and electrical conductivity (strength of the nutrient solution) is essential in the effort to produce the highest quality yields. Special sensor probes are inserted into the medium and data for temperature, moisture level, and electrical conductivity are collected and stored. Growers use this data to determine the strength of the nutrient solution they feed the plants, and precisely how often they feed the plants. When the moisture level of the medium drops to a certain saturation percentage, the plants should receive a precise dosing of nutrient solution to rehydrate the medium and feed the plants. The exact intervals at which this happens are crucial. Current systems provide growers with substrate data, but they are not coupled with any type of controller that acts on the data in order to automatically maintain substrate parameters, and account for these parameters in effecting environmental humidity and temperature in the room.

GC Devices monitor substrate and talk with other GC Devices, like the Advanced Irrigation Controller, and the GC App algorithms automatically (and in some instances predictively) maintain substrate parameters within the user-defined range, eliminating the need for human analysis of the substrate data and physical programming of the irrigation controller. In combination with GC Devices Substrate Monitoring, the AIC can automatically maintain substrate parameters without extra user intervention. Specifically, the AIC can deliver to the plants the precise strength nutrient solution recipe at precisely the right time, and account for the effects of these deliveries upon the room atmosphere.

### Scanning Algorithm

The GC Scanning Algorithm (SA) is a high-level tool for analyzing user account and device usage. The possibilities of the SA are far ranging. Some examples are:
a. User rooms are monitored for deficiencies; our SA will analyze and compare user parameters vs. actual outcomes and where there are large deviations, recommend additional equipment that can bring outcomes into compliance with expectations.
b. User rooms are monitored through all plant growth stages and specific product recommendations, based on current or upcoming cycles, are pushed to the user via SMS, email, or direct messaging.
c. An AI service, which will automatically monitor a user's account for all critical health issues, can be marketed and sold as a subscription service.
d. SA is used as an AI automated support and diagnostic tool for any support-related issues, quickly diagnosing almost any type of problem and automatically correcting the problem, or providing the user with suggested corrective remedies.
e. SA may be used to collect data and intelligence such as annual crop output size per room, facility, geolocation, etc.
f. SA can also be used to estimate the size of the black market by comparing registered system users and geolocations to licensed entities.

1. A method for managing an indoor hydroponic system, the method comprising:
providing a plurality of sensors in a hydroponic growth room;
communicating data from the plurality of sensors to a computer readable storage medium having program instructions;
analyzing the sensed data from the plurality of sensors using the computer readable storage medium;
comparing the analyzed sensed data with a predetermined optimal growth room using the computer readable storage medium;
determining one or more changes needed in the sensed data to accomplish the predetermined optimal growth room;
communicating the one or more changes to a climate control suite to enact the one or more changes; and
monitoring data communicated from the plurality of sensors to arrive at the predetermined optimal growth room.

2. The method of claim 1, further comprising, communicating data amongst the plurality of sensors.

3. The method of claim 1, wherein the climate control suite is configured to alter environmental conditions selected from the group consisting of: temperature, humidity, carbon-dioxide levels, oxygen levels, soil nutrition, soil pH levels, combinations thereof, and alternatives therefrom.

4. The method of claim 1, wherein the one or more changes to a climate control suite to enact the one or more changes to the predetermined optimal growth room is determined by a vapor-pressure deficit.

5. The method of claim 1, wherein the climate control suite is configured to alter soil conditions selected from the group consisting of: temperature, moisture, pH levels, electrical conductivity, combinations thereof, and alternatives therefrom.

6. The method of claim 1, further comprising a computing unit to communicate with outside computing routed over an Internet backbone or “cloud” (“IoT”) for communicating the one or more changes to a climate control suite to enact the one or more changes

7. The method of claim 6, further comprising the fog computing unit for optimizing the predetermined optimal growth room using the climate control suite, by incorporating an optimized artificial intelligence (AI) model.

8. The method of claim 1, wherein the climate control suite may be incorporated locally within the hydroponic growth room to neutralize climate inconsistencies within the hydroponic growth room.

9. The method of claim 1, further comprising an integrated Internet of Things (“IoT”) connected system comprising of hardware and software with artificial intelligence, wherein the IoT connected system incorporates wireless sensing capability to collect and monitor real time data using internet, satellite or other communication means, via one or more computers.

10. A hydroponic system comprising:
a plurality of sensors in a hydroponic growth room;
a data communication link from the plurality of sensors to a computer readable storage medium having program instructions; and
an algorithm on the computer readable storage medium capable of analyzing the sensed data from the plurality of sensors using program instructions,
wherein the system compares the analyzed sensed data against a predetermined optimal growth room; determines one or more changes needed in the sensed data to accomplish the predetermined optimal growth room; communicates the one or more changes to a climate control suite to enact the one or more changes; and
monitors the data communicated from the plurality of sensors to arrive at the predetermined optimal growth room.

11. The system of claim 10, further comprising, communicating data amongst the plurality of sensors.

12. The system of claim 10, wherein the climate control suite is configured to alter environmental conditions selected from the group consisting of: temperature, humidity, carbon-dioxide levels, oxygen levels, soil nutrition, soil pH levels, combinations thereof, and alternatives therefrom.

13. The system of claim 10, wherein the one or more changes to a climate control suite to enact the one or more changes to the predetermined optimal growth room is determined by a vapor-pressure deficit.

14. The system of claim 10, wherein the climate control suite is configured to alter soil conditions selected from the group consisting of: temperature, moisture, pH levels, electrical conductivity, combinations thereof, and alternatives therefrom.

15. The system of claim 10, further comprising a computing unit to communicate with outside computing routed over an Internet backbone or “cloud” (“IoT”) for communicating the one or more changes to a climate control suite to enact the one or more changes

16. The system of claim 10, further comprising the fog computing unit for optimizing the predetermined optimal growth room using the climate control suite, by incorporating an optimized artificial intelligence (AI) model.

17. The system of claim 10, wherein the climate control suite may be incorporated locally within the hydroponic growth room to neutralize climate inconsistencies within the hydroponic growth room.

18. The system of claim 10, further comprising an integrated Internet of Things (“IoT”) connected system comprising of hardware and software with artificial Intelligence, wherein the IoT connected system incorporates wireless sensing capability to collect and monitor real time data using internet, satellite or other communication means, via one or more computers.
